(19) United States
(12) Patent Application Publication
(10) Pub. No.: US 2018/0007336 A1
(43) Pub. Date: Jan. 4, 2018

(54) CORRELATION BASED APPROACH FOR SKIPPING FRAMES

(71) Applicant: QUALCOMM Incorporated, San Diego, CA (US)

(72) Inventors: Soman Nikhara, Hyderabad (IN); Vignesh Bhuvaneshwar, San Diego, CA (US)

(21) Appl. No.: 15/366,973

(22) Filed: Dec. 1, 2016

(30) Foreign Application Priority Data
Jul. 1, 2016 (IN) 201621022653

(51) Int. Cl. H04N 9/73; H04N 5/232

(52) U.S. Cl. CPC H04N 9/735; H04N 5/23229; H04N 5/23238

(57) ABSTRACT

Certain aspects relate to systems, methods, devices and non-transient computer readable medium for correlation based frame skipping of processing intensive image processing algorithms for image adjustments, such as automatic white balance (AWB) operations and automatic exposure correction (AEC) operations. In certain embodiments, if a scene is deemed stable based on determining a correlation between the statistics associated with a current and previous frames, certain steps for the purpose of performing processing intensive image processing algorithms, such as AWB operations and AEC operations, may be skipped.

### CROSS-REFERENCES TO RELATED APPLICATIONS

This application is a non-provisional application and claims the benefit and priority of Indian Provisional Application No. 201621022653, filed on Jul. 1, 2016, titled “CORRELATION BASED APPROACH FOR SKIPPING FRAMES,” which is herein incorporated by reference in its entirety for all purposes.

### BACKGROUND

The systems and methods disclosed herein are directed to digital imaging, and, more particularly, to dynamically skip processing of image data while improving image quality.

Examples of techniques used for improving image quality may include configuring and performing automatic white balance (AWB), automatic exposure correction and other suitable image processing techniques. White balance involves the process of removing unrealistic color casts from images so that objects which appear white in person are rendered white in the image. Improper white balance can create unsightly blue, orange, or even green color casts. Proper white balance takes into account the color temperature of a light source, which refers to the relative warmth or coolness of the light—light sources, also referred to as illuminants herein, may not be pure white, but instead have a bias towards a particular color. Human perception is able to compensate for illumination that is not pure white, so colors appear relatively consistent over a wide range of lighting conditions.

Cameras, however, may perceive the same scene differently when the illuminant changes. A typical sensor used in an electronic image capture device, such as a digital camera or video recorder, may capture an image that exhibits a color shift attributable to illumination from a non-pure white source. The color shift exhibited in the captured image may appear unnatural to the human eye and create a perception that the sensor or capture device is of low quality due to being unable to accurately capture real world images.

Cameras perform automatic white balance (AWB) to attempt to determine what objects are white when illuminated by light sources of different color temperatures. A captured image may be processed to compensate for lighting conditions and color temperature of the illuminant. White balance compensation depends on the color temperature of the illuminant. White balance compensation configured for an illuminant at a first color temperature may not be correct for color temperature of a second illuminant, and may further degrade image quality by introducing additional color shift into the image. When color tone in a digital image is off, for example, due to no white balancing or incorrect white balancing, human perception of the image may be objectionable.

Configuring exposure for a camera refers to configuring the exposure to light for capturing images. For example, simplistically, exposure may determine how light or dark an image will appear when it is captured. Human eyes naturally adjust to different light conditions; however, the camera needs to (either manually or automatically) adjust to the source of light, amount of light and the sensitivity to light for capturing good quality images. Configuring optimal exposure may include configuring the aperture (i.e., area over which light can enter the image sensor), shutter speed (i.e., duration for which light is captured) and sensitivity (e.g., ISO speed) of the image sensor for given light conditions.

### BRIEF SUMMARY

The systems, methods and devices of this disclosure each have several innovative aspects, no single one of which is solely responsible for the desirable attributes disclosed herein.

In general, this disclosure is related to correlation based frame skip in automatic white balance. Digital cameras features provide automatic white balance (AWB) whereby the camera analyzes the overall color of an image and calculates the best-fit white balance. To illustrate, a camera may capture frames (also referred to herein as statistics frames) at a frame rate of 30 fps. These frames, also referred to as statistics frames, may be used to generate data for performing AWB calculations as well as other image processing operations, for instance automatic focus and automatic exposure control. AWB calculations are typically performed on every alternate statistics frame. As such, the AWB algorithm can be computationally intensive, causing high central processing unit (CPU) and/or image processor usage and lead to high usage of device power, which can be particularly undesirable in portable devices using stored power.

In some embodiments, techniques are disclosed for skipping the computationally expensive image processing operations, such as automatic focus, automatic exposure control and/or AWB operations for one or more frames based on the correlation between the statistics for a current frame and a previous frame. For example, in certain instances, the change in statistics for a frame may be minimal for stable scenes, for which AWB and other image processing steps may be skipped. In some embodiments, other techniques such as dynamically computing frame skip using AWB and other image processing operations may be used in conjunction with correlation based frame skipping, without deviating from the scope of the disclosure.

An example device for capturing images may include several components, such as a sensor to sense image data for a current frame and a processor. The processor may receive image statistics generated using the image data for the current frame. In certain aspects, deriving image statistics for the current frame may include deriving red, green and blue information from the image data for each of a plurality of sub-regions of the current frame. The processor may be further configured to determine correlation between the current frame and a previous frame using the image statistics for the current frame and image statistics for the previous frame, wherein the previous frame is a frame prior to the current frame in a sequence of frames; determine whether the correlation is below a first threshold; and based on the determination that the correlation is below the first threshold, generate image color feedback by processing of the image statistics for the frame. However, if the determination is that the correlation is equal to or above the first threshold, the processor may skip generating the image color feedback by skipping processing of the image statistics for the current frame.

In certain implementations, determining the correlation includes using green information from the image statistics for each of a plurality of sub-regions between the current frame and the previous frame. In certain implementations, determining the correlation includes using a subset of the image statistics associated with a subset of a plurality of sub-regions for the current frame and the previous frames.

In certain aspects, processing image statistics may include performing automatic white balancing operations, automatic exposure correction operations or other image correction/improvement operations. The image color feedback may be one or more of color temperature or red, blue, green (RGB) gains.

In certain embodiments, dynamic frame skipping may be performed after generating the image color feedback by processing of the image statistics from the current frame. In certain implementations, the processor is configured to determine correlation for future frames for skipping the future frames if the current frame is determined to be a frame from a stable scene using dynamic frame skipping.

In certain examples, the processor may further compare, after generating the image color feedback for the current frame, the image color feedback for the current frame and an image color feedback for a different previous frame; determine a change between the image color feedback for the current frame and the image color feedback for the different previous frame, based on the comparison; and determine to skip a first number of frames for performing correlation determination and image color feedback generation for future frames, based on determining that the change is below a second threshold. Furthermore, in certain aspects, upon skipping the correlation determination and the image color feedback generation for the first number of frames, the processor may receive image statistics for a new frame; determine correlation between the new frame and a previous frame to the new frame using the image statistics for the new frame and image statistics for the previous frame to the new frame; and based on the determination that the correlation is equal to or above the first threshold, skip correlation determination and image color feedback generation for an additional first number of frames.

In certain aspects of the disclosure, the processor may be an image signal processor or a general purpose processor.

An example method for capturing images may include accessing image statistics generated using image data for a current frame, wherein image statistics comprises red, green and blue information from the image data for each of a plurality of sub-regions of the current frame; determining correlation between the current frame and a previous frame using the image statistics for the current frame and image statistics for the previous frame, wherein the previous frame is a frame prior to the current frame in a sequence of frames; determining whether the correlation is below a first threshold, and based on the determination that the correlation is below the first threshold; generating image color feedback by processing of the image statistics for the current frame. In one implementation, if the method determines that the correlation is equal to or above the first threshold, the method skips generation of the image color feedback by skipping processing of the image statistics for the current frame.

In certain aspects of the disclosure, processing of the image statistics comprises performing automatic white balancing operations or automatic exposure correction operations. In certain aspects of the disclosure, determining correlation comprises generating the correlation using green information from the image statistics for each of the plurality of sub-regions between the current frame and the previous frame. The image color feedback may be one or more of color temperature or red, blue, green (RGB) gains.

In certain embodiments, the method further includes comparing, after generating the image color feedback for the current frame, the image color feedback for the current frame and an image color feedback for a different previous frame; determining a change between the image color feedback for the current frame and the image color feedback for the different previous frame, based on the comparison; and determining to skip a first number of frames for performing correlation determination and image color feedback generation for future frames, based on determining that the change is below a second threshold. In certain implementations, upon skipping the correlation determination and the image color feedback generation for the first number of frames, the method may further include receiving image statistics for a new frame; determining correlation between the new frame and a previous frame to the new frame using the image statistics for the new frame and image statistics for the previous frame to the new frame; and based on the determination that the correlation is equal to or above the first threshold, skip correlation determination and image color feedback generation for an additional first number of frames. In certain implementations, the method includes determining correlation for future frames for skipping the future frames if the current frame is determined to be a frame from a stable scene using dynamic frame skipping.

An example apparatus for capturing images may include means for accessing image statistics generated using image data for a current frame, wherein image statistics comprises red, green and blue information from the image data for each of a plurality of sub-regions of the current frame; means for determining correlation between the current frame and a previous frame using the image statistics for the current frame and image statistics for the previous frame, wherein the previous frame is a frame prior to the current frame in a sequence of frames; means for determining whether the correlation is below a first threshold, and based on the determination that the correlation is below the first threshold; means for generating image color feedback by processing of the image statistics for the current frame.

In certain aspects, the apparatus may further include, based on the determining that the correlation is equal to or above the first threshold; means for skipping generation of the image color feedback by skipping processing of the image statistics for the current frame. In certain aspects, processing of the image statistics comprises performing automatic white balancing. In certain aspects, the image color feedback may include one or more of color temperature or red, blue, green (RGB) gains.

An example non-transitory computer-readable storage medium may include machine-readable instructions stored thereon for accessing image statistics generated using image data for a current frame, wherein image statistics comprises red, green and blue information from the image data for each of a plurality of sub-regions of the current frame; determining correlation between the current frame and a previous frame using the image statistics for the current frame and image statistics for the previous frame, wherein the previous frame is a frame prior to the current frame in a sequence of frames; determining whether the correlation is below a stable threshold; and based on the determination that the correlation is below the stable threshold, means for generating image color feedback by processing of the image statistics for the current frame. In certain aspects, the non-transitory computer-readable storage medium may further include, based on the determining that the correlation is equal to or above the stable threshold, means for skipping generation of the image color feedback by skipping processing of the image statistics for the current frame. In certain implementations, processing of the image statistics may include performing automatic white balancing operations.

### BRIEF DESCRIPTION OF THE DRAWINGS

Aspects of the disclosure are illustrated by way of example. The following description is provided with reference to the drawings, where like reference numerals are used to refer to like elements throughout. While various details of one or more techniques are described herein, other techniques are also possible. In some instances, well-known structures and devices are shown in block diagram form in order to facilitate describing various techniques.

A further understanding of the nature and advantages of examples provided by the disclosure may be realized by reference to the remaining portions of the specification and the drawings.

FIG. 1A illustrates a high-level schematic diagram of an example image capture device with dynamic frame skip capabilities.

FIG. 1B illustrates example data communications between some of the components illustrated in FIG. 1A.

FIG. 2 illustrates a flowchart for an automatic white balance process implementing frame skipping techniques described herein.

FIG. 3 illustrates a flowchart for an automatic white balance process of FIG. 2 using correlation based frame skipping techniques described herein.

FIG. 4A illustrates an example Bayer Grid used in aspects of this disclosure.

FIG. 4B illustrates an image/frame subdivided into a number of portions/areas of interest for generating Bayer Grid statistics for the frame.

FIG. 5 illustrates a flowchart for an automatic white balance process implementing the frame skipping techniques described herein.

FIG. 6 illustrates a flowchart for an automatic white balance process of FIG. 5 using correlation based frame skipping techniques described herein.

FIG. 7 illustrates a flowchart for an automatic white balance process of FIG. 5 using dynamic frame skipping techniques described herein.

FIG. 8 illustrates another flowchart of an example embodiment of an AWB process 800 implementing correlation based frame skipping techniques described herein.

FIG. 9A illustrates example data collected for correlation factor vs. frame number for a stable scene.

FIG. 9B illustrates example data collected for correlation factor vs. frame number for an unstable scene.

FIG. 10 illustrates an example of a computing system in which one or more aspects of the disclosure may be implemented.

### DETAILED DESCRIPTION

Several illustrative embodiments will now be described with respect to the accompanying drawings, which form a part hereof. While particular embodiments, in which one or more aspects of the disclosure may be implemented, are described below, other embodiments may be used and various modifications may be made without departing from the scope of the disclosure or the spirit of the appended claims.

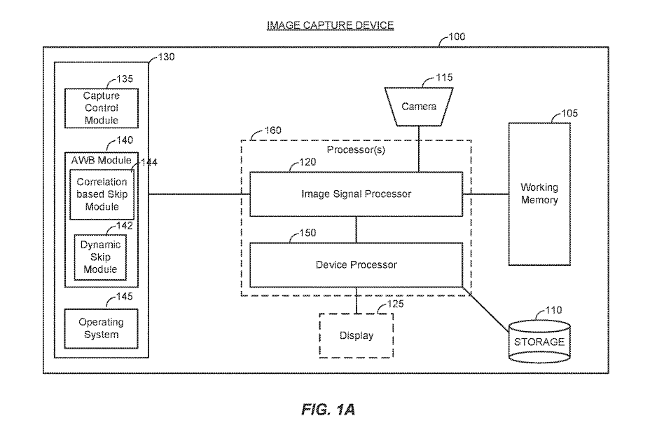

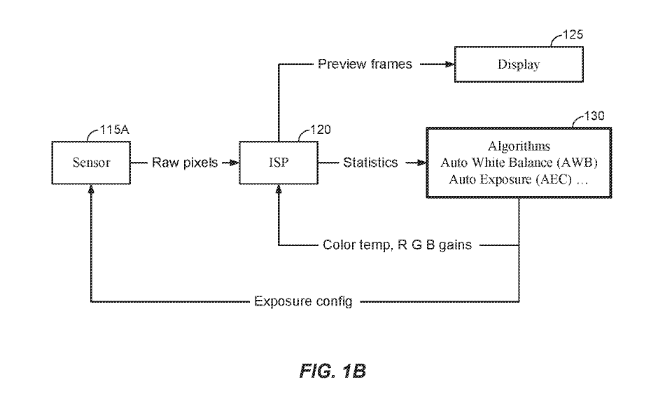

According to one or more aspects, any and/or all of the apparatus modules, circuitry, methods and/or method steps described in FIGS. 1-10 herein may be implemented by and/or in an electrical circuit or a computing device. Additionally, or alternatively, any and/or all of the methods and/or method steps described herein may be implemented in computer-readable instructions, such as computer-readable instructions stored on a computer-readable medium, such as memory, storage or another computer-readable medium.

FIG. 1A illustrates a high-level schematic diagram of an embodiment of an image capture device 100 with correlation frame skipping and/or dynamic frame skipping capabilities, the device 100 having a set of components including an image processor 120 linked to a camera 115. The image signal processor 120 is also in communication with a working memory 105, memory 130, and device processor 150, which in turn is in communication with storage 110 and an optional electronic display 125.

Device 100 may be a portable personal computing device, e.g., a mobile phone, digital camera, tablet computer, personal digital assistant, or the like. There are many portable computing devices in which using the frame skipping capabilities techniques as described herein would provide advantages. In certain embodiments, device 100 may also be a stationary computing device or any device. A plurality of applications may be available to the user on device 100. These applications may include traditional photographic and video applications as well as applications relating to frame skip configuration.

The image capture device 100 includes camera 115 for capturing external images. The camera 115 can include an image sensor, color filter array, and associated lens assembly. The image sensor can include an array of photosensitive elements for converting incident light into electric signals. Such image sensors may include, in certain embodiments, a charge-coupled device (CCD), complementary metal oxide semiconductor sensor (CMOS), or any other image sensing device that receives light and generates image data in response to the received light. The sensor may be provided with an overlying color filter array, for example, the RGGB Bayer color filter, so that image data captured by the sensor includes a number of color channels corresponding to the wavelength pass ranges of the color filter array. The present disclosure is described primarily in the context of RGB gains, as RGB image data is produced by sensors having the conventional Bayer pattern. However, the disclosed frame skip techniques can be modified to operate on image data in other color spaces as produced by the color filter array of the camera 115. Such other color spaces can include the RGBN, YCbCr, YUV, and YIQ color spaces, to name a few examples, and the color filter array can include a mosaic of band-pass color filters corresponding to the channels of these color spaces. The image sensor may be able to obtain image data of still photographs and may also provide information regarding motion in a captured video stream. Camera 115 may include one individual sensor or may include arrays of sensors. The camera 115 can be configured for continuous or intermittent capture of preview frames and pre-flash image capture, as well as capture of full resolution final images.

The image signal processor 120 may be configured to perform various processing operations on received statistics frames (which can be displayed as preview frames) in order to execute frame skipping. Image signal processor 120 may be a general purpose processing unit or a processor specially designed for imaging applications. Examples of image processing operations include automatic white balancing (AWB) and automatic exposure correction (AEC) data generation, automatic focus, cropping, scaling (e.g., to a different resolution), image stitching, image format conversion, color interpolation, color processing, image filtering (e.g., spatial image filtering), lens artifact or defect correction, etc. Image signal processor 120 may, in some embodiments, comprise a plurality of processors. Image signal processor 120 may be one or more dedicated image signal processors (ISPs) or a software implementation of a processor.

As shown, the image signal processor 120 is connected to a memory 130 and a working memory 105. In the illustrated embodiment, the memory 130 stores capture control module 135, AWB module 140 including correlation based skip module 144 and dynamic skip module 142 and operating system 145. The modules of the memory 130 include instructions that configure the image signal processor 120 of device processor 150 to perform various image capture, image processing, and device management tasks. Working memory 105 may be used by image processor 120 to store a working set of processor instructions contained in the modules of memory 130. Alternatively, working memory 105 may also be used by image processor 120 to store dynamic data created during the operation of device 100.

AWB 140 can perform AWB calculations on statistics frames, and can also store sub-modules—correlation based skip module 144 and dynamic skip module 142. Together, these modules can cooperate to perform the correlation frame skipping and/or dynamic frame skipping calculations and associated AWB techniques.

Correlation based skip module 144 and dynamic skip module 142 can store instructions that configure the processor 120 to analyze statistics associated with one or more frames from successive frames. As will be described in more detail, the correlation skip module may be configured to determine the correlation between the statistics for multiple frames and skip AWB operations for one or more frames to reduce processor usage and associated power consumption.

As mentioned above, the image signal processor 120 is configured by several modules stored in the memories. The capture control module 135 may include instructions that configure the image signal processor 120 to adjust the focus position of camera 115. Capture control module 135 may further include instructions that control the overall image capture functions of the device 100. For example, capture control module 135 may include instructions that call subroutines to configure the image signal processor 120 to capture preview image data including one or more frames of a target image scene using the camera 115. In one embodiment, capture control module 135 may then call the AWB module 140 to perform frame skip calculations and AWB calculations.

Operating system module 145 configures the image signal processor 120 to manage the working memory 105 and the processing resources of device 100. For example, operating system module 145 may include device drivers to manage hardware resources, for example, the camera 115. Therefore, in some embodiments, instructions contained in the image signal processing modules discussed above may not interact with these hardware resources directly, but instead interact through standard subroutines or APIs located in operating system component 145. Instructions within operating system 145 may then interact directly with these hardware components. Operating system module 145 may further configure the image signal processor 120 to share information with device processor 150.

Device processor 150 may be configured to control the display 125 to display the captured image, or a preview of the captured image, to a user. The display 125 may be external to the imaging device 100. The display 125 may also be configured to provide a view finder displaying a preview image for a use prior to capturing an image, for example, present the user with a visual representation of the image with AWB corrected color cast or with a user interface for adjusting frame skip parameters. The display 125 may comprise an LCD or LED screen, and may implement touch sensitive technologies.

Device processor 150 may write data to storage module 110, for example, data representing captured images and RGB gains. While storage module 110 is represented graphically as a traditional disk device, those with skill in the art would understand that the storage module 110 may be configured as any storage media device. For example, the storage module 110 may include a disk drive, e.g., a floppy disk drive, hard disk drive, optical disk drive or magneto-optical disk drive, or a solid state memory e.g., a FLASH memory, RAM, ROM, and/or EEPROM. The storage module 110 can also include multiple memory units, and any one of the memory units may be configured to be within the image capture device 100, or may be external to the image capture device 100. For example, the storage module 110 may include a ROM memory containing system program instructions stored within the image capture device 100. The storage module 110 may also include memory cards or high speed memories configured to store captured images which may be removable from the camera. The storage module 110 can also be external to device 100, and in one example, device 100 may wirelessly transmit data to the storage module 110, for example, over a network connection.

Although, FIG. 1A discloses image signal processor 120 and device processor 150, in certain other embodiments as two different components, the processing tasks disclosed by the image signal processor 120 and device processor 150 may be redistributed amongst one or more processors in the processor 160 without deviating from the scope of the disclosure.

Furthermore, FIG. 1A depicts a device having separate components to include a processor, imaging sensor, and memory. One skilled in the art would recognize that these separate components may be combined in a variety of ways to achieve particular design objectives. For example, in an alternative embodiment, the memory components may be combined with processor components or several processor components may be combined together, for example, to save cost and/or to improve performance.

Additionally, although FIG. 1A illustrates two memory components, including memory component 120 comprising several modules and a separate memory 105 comprising a working memory, one with skill in the art would recognize several embodiments utilizing different memory architectures. For example, a design may utilize ROM or static RAM memory for the storage of processor instructions implementing the modules contained in memory 130. The processor instructions may be loaded into RAM to facilitate execution by the image signal processor 120. For example, working memory 105 may comprise RAM memory, with instructions loaded into working memory 105 before execution by the processor 120.

FIG. 1B illustrates example data communications between some of the components illustrated in FIG. 1A. For instance, sensor 115A of camera 115 can send data representing pixel values to the image signal processor (ISP) 120. The ISP 120 can use the pixel values to generate and send preview frames to a display 125. For example, the preview frames can include image data with automatic white balance (AWB) corrections and automatic exposure correction (AEC).

The ISP 120 can also generate and send statistics to image processing modules 130, for example, for performing AWB operations, AEC operations, and the like (module 130). In certain embodiments, certain modules from the image processing modules 130 may be executed using the ISP 120 or a general purpose processor other than the ISP 120.

In certain implementations, image data for a frame acquired by the sensor 115A of the camera 115 may be subdivided into multiple portions/areas of interest. In such implementations, statistics for a frame may refer to the collective statistics for each of the multiple portions/areas of interest and statistics for each of the portions/areas of interest may refer to the collective representation of each color from a selected group of colors. For example, in one implementation, red, blue and green for each of the portions or areas may be summed or averaged together to form red, blue and green channels, with each portion/area of interest having a statistic for the red, blue and green channel. Collectively, all this information for a frame may be referred to as statistics for the frame or frame statistics.

The various modules in the image processing module 130 can use the statistics for each of the frames to generate image color feedback, such as color temperature and RGB gains back. The image color feedback may be generated by executing various algorithms on the ISP 120 (or other processors), such as AWB and AEC algorithms. Executing such image processing algorithms may be processing power intensive and time consuming.

The ISP 120 may use image color feedback for generation of preview frames from the pixel values, to generate and send exposure configurations back to the sensor 115A, or a variety of other tasks. Other image capture parameters can be output back to sensor 115A, for example, autofocus configurations.

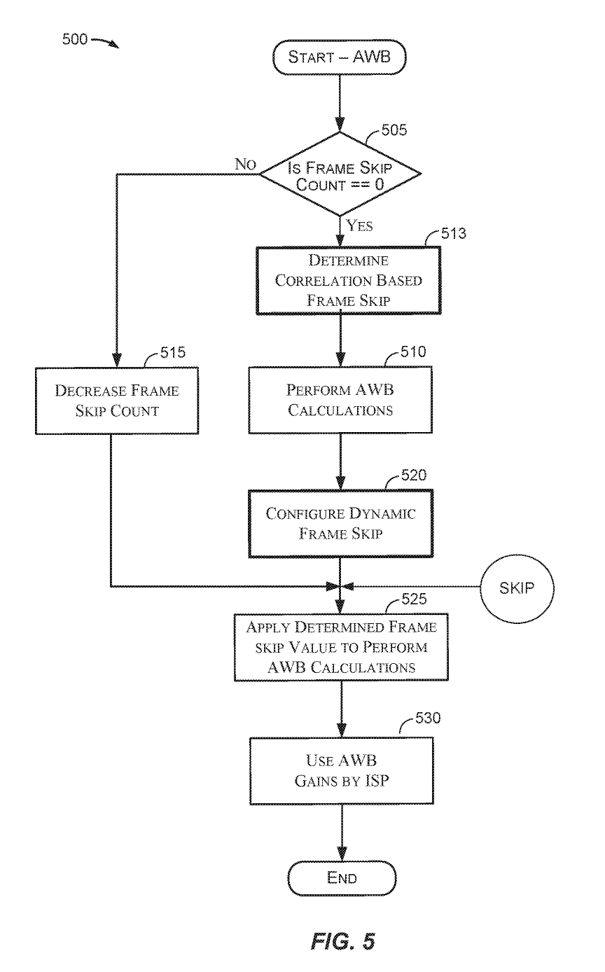

Aspects of the disclosure describe skipping execution of AWB and other algorithms from the image processing module 130 for one or more frames for stable scenes. In certain embodiments, aspects of the disclosure determine stable scenes by determining correlation between the statistics for the current frame with prior frames before executing the AWB and other processing intensive algorithms or operations. For stable scenes or stable operating environments, aspects of the disclosure may altogether skip execution of AWB and other processing intensive algorithms or operations for one or more frames. As disclosed herein, this may be referred to as correlation based frame skipping (CFS) for image processing. Such correlation based skipping of frames may be implemented in conjunction with other algorithm skipping techniques for image data associated with frames, such as dynamic frame skipping (DFS), disclosed in more detail with respect to FIG. 5 or static frame skipping techniques.

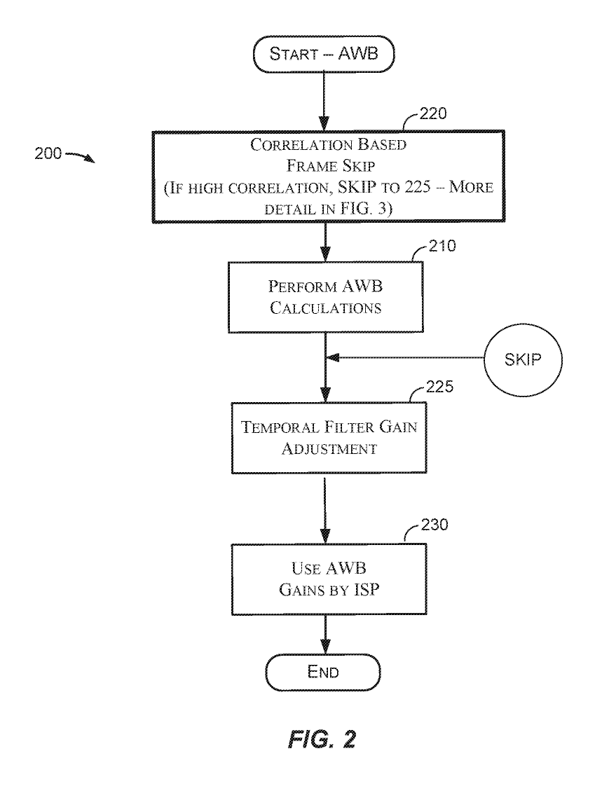

FIG. 2 illustrates a flowchart of an example embodiment of an AWB process 200 implementing correlation based frame skipping techniques described herein. In certain implementations, process 200 can be carried out by the AWB module 140 described in FIGS. 1A and 1B, as disclosed above. Although, FIG. 2 discloses performing an AWB process 200, other image processing algorithms may be performed in a similar manner as disclosed herein. For example, an AEC process may be similarly performed by opportunistically skipping processing intensive blocks of calculating AEC for relatively stable scenes with respect to previous frames/scenes.

To begin, AWB is initialized. The AWB module 140 performs a correlation based frame skip determination at block 220 to determine if the AWB processing intensive operations for the current frame statistics can be skipped based on comparing the frame statistics for the current frame to statistics of prior frames. Based on the correlation, if the AWB module 140 determines that the AWB calculation for the current frame statistics can be skipped (i.e., the scene is stable), then processes associated with block 210 (performing AWB calculations) are skipped. Furthermore, in certain instances, the correlation based skip module 144 may also direct the state machine not only to skip the current AWB processing at block 210 for process 200, but also for one or more forthcoming frames.

However, if the frame is not skipped based on the correlations generated in block 220, at block 210 the AWB module 140 executes the processing intensive tasks of AWB operations to screen the statistics and run heuristics on captured image frames. Although this disclosure discusses AWB for illustrative purposes, other image processing functions such as AEC, etc., may be performed without deviating from the scope of the disclosure.

At block 225, the AWB module 140 engages an AWB temporal filter during the frame skips to facilitate smooth convergence of the images during frame skip process. At block 230, the AWB gains and color temperature calculated by block 210 are used as image color feedback by the ISP 120 of FIG. 1B.

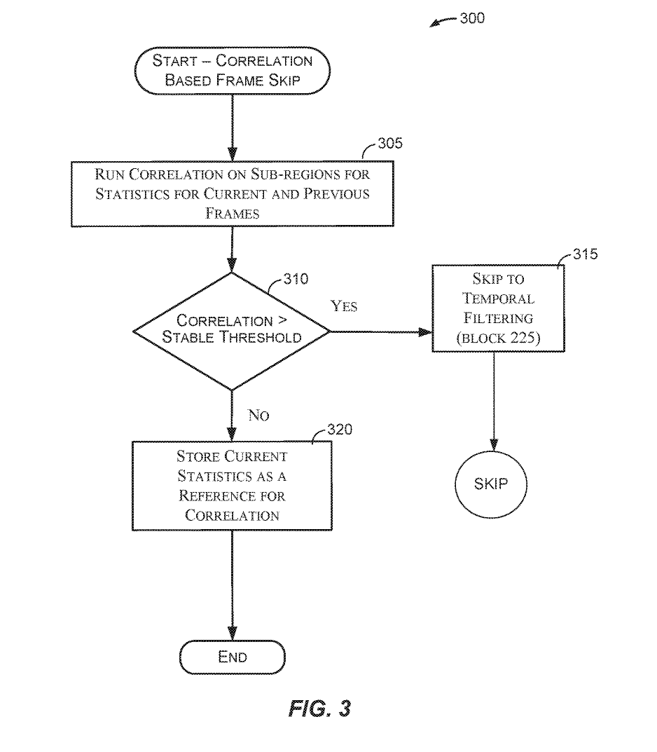

FIG. 3 illustrates a flowchart of an example embodiment of a correlation based frame skipping process 300 that can be used in some implementations as block 220 of the AWB process 200 of FIG. 2. In some embodiments, process 300 can be carried out by correlation based skip module 144.

To begin, correlation based frame skip determination is initialized. At block 305, the correlation based skip module 144 may execute the correlation algorithm for statistics for sub-regions for current and previous frames. In certain embodiments, the frame may be divided into a number of sub-regions where a subset of the plurality of sub-regions may be used in determining the correlation. For example, out of 3072 (64×48) sub-regions of a frame, in certain implementations it may be suitable to use statistics for 256 sub-regions for determining the correlation between any two frames. Reducing the number of sub-regions for which statistics are used in determining the correlation between two frames may further increase the speed of such a determination and also reduce the overall processing power needed for the AWB process 200.

At block 305, the correlation based skip module 144 determines if the correlation is high between the previous and the current frames by analyzing the statistics for each frame. If the correlation is high, the correlation based skip module 144 may cause the AWB process 200 to skip the AWB processing (block 210) in FIG. 2 and save processing resources and power (block 315).

However, on the other hand, if the correlation based skip module 144 determines low correlation between the current and prior frames based on analyzing the statistics for the respective frames, potentially indicating that the current frame may be part of a sequence of changing scenes (i.e., unstable scene), the process 300 may save the current statistics or portion of the statistics (e.g., for 256 samples for selected sub-regions for correlation) as a reference for correlation calculations for future frames (block 320) and end the current correlation based frame skip process 300 and continue with AWB processing at step 210 of FIG. 2.

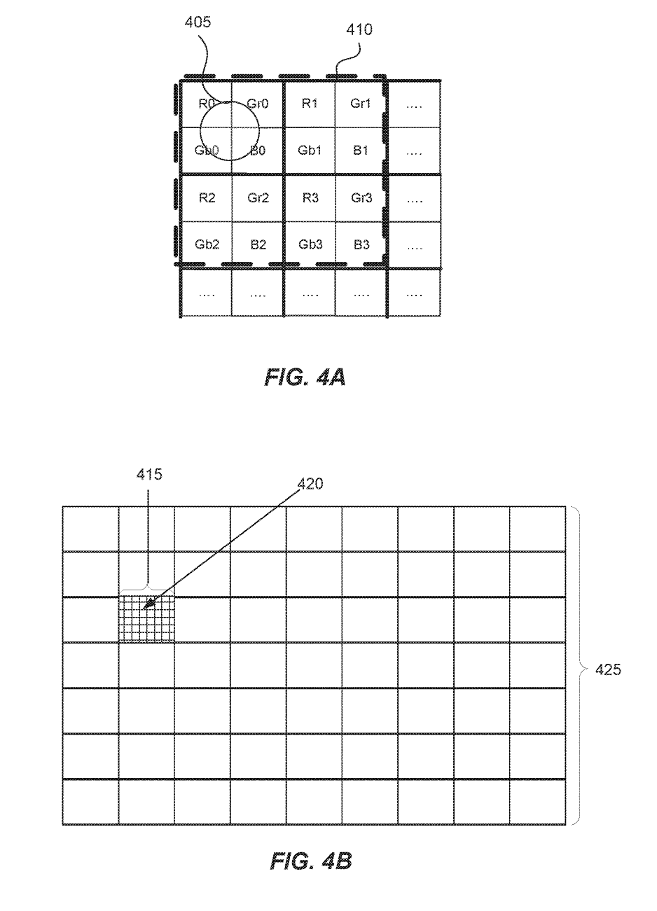

FIG. 4A provides an illustrative technique for determining the correlations between statistics of current and previous frames. As shown in FIG. 4A, in one embodiment, the correlation based skip frame module 144 computes correlation between Beyer Grid (BG) statistics of current and previously used statistics frame.

A camera sensor uses an array of tiny light cavities or “photosites” to record an image. Conceptually, a filter is placed over each cavity that permits only particular colors of light, such as red, blue or green. As a result, the camera approximates the other two primary colors in order to have full color at every pixel. One of the most common types of color filter array is called a “Bayer array,” or “Bayer Grid.” FIG. 4A displays an example of a 2×2 pixel as a group of the Bayer Grid (e.g., 405). A Bayer Grid consists of alternating rows of red-green and green-blue filters. However, each primary color may not receive an equal fraction of the total area because the human eye is more sensitive to green light than both red and blue light. As illustrated in FIG. 4A and again later in FIG. 4B, several pixels together may be considered as a sub-region of the frame (e.g., block 410).

FIG. 4B illustrates an image/frame 425 subdivided into a number of sub-regions for generating Bayer Grid statistics for the frame. Block 415 represents one illustrative sub-region out of several sub-regions for the image. And block 420 represents one Bayer Grid from a plurality of Bayer Grids included in each sub-region. In one implementation, 3072 (64×48) statistics may be provided for processing to the AWB module 140. For example, a statistics frame may have a red, blue and green channel.

In certain implementations, a frame acquired by the camera may be subdivided into sub-regions (e.g., block 415) for each frame. In such implementations, statistics for a frame may refer to the collective statistics for each (of the selected one) of the multiple portions/areas of interest and statistics for each of the portions/areas of interest may refer to the collective representation of each color from a selected group of colors. For example, in an implementation using the Bayer Grid, as illustrated in FIG. 4A; red, blue and green for each of the sub-regions may be summed or averaged together to form red, blue and green channels, with each portion/area of interest having a statistic for the red, blue and green channel. Collectively, all this information for a frame may be referred to as statistics for the frame or frame statistics.

In correlation based frame skipping, only a subset of all the statistics may be needed to generate a reliable correlation between two frames. Reducing the number of subsamples needed for a reliable correlation also reduces the computational power and latency associated with such calculations. For example, in one implementation, only 256 samples may be used in generating the correlation. Furthermore, in some implementations, considering just the Gr average array of current and previously used frame may be sufficient in determining the correlation. Following is an example of Pearson's equation for determining correlation between statistics between a current and a previous frame.

$${r}_{xy} = \frac{{\sum }_{i = 1}^{n} ( {x}_{i} - \overline{x} ) ( {y}_{i} - \overline{y} )}{\sqrt{{\sum }_{i = 1}^{n} {( {x}_{i} - \overline{x} )}^{2} {\sum }_{i = 1}^{n} {( {y}_{i} - \overline{y} )}^{2}}}$$

In certain implantations, when the above Pearson's equation is applied to the aspects of the disclosure, x may refer to the current frame statistics, x (bar) may refer to the mean of current frame statistics, y may refer to the previous frame statistics, and y (bar) may refer to mean of previous frame statistics.

FIG. 5 illustrates a flowchart of an example embodiment of an AWB process 500 implementing the frame skipping techniques described herein. Process 500 can be carried out by AWB module 140 in some implementations. FIG. 5 illustrates example techniques for implementing correlation based frame skipping in conjunction with other frame skipping techniques, such as dynamic frame skipping.

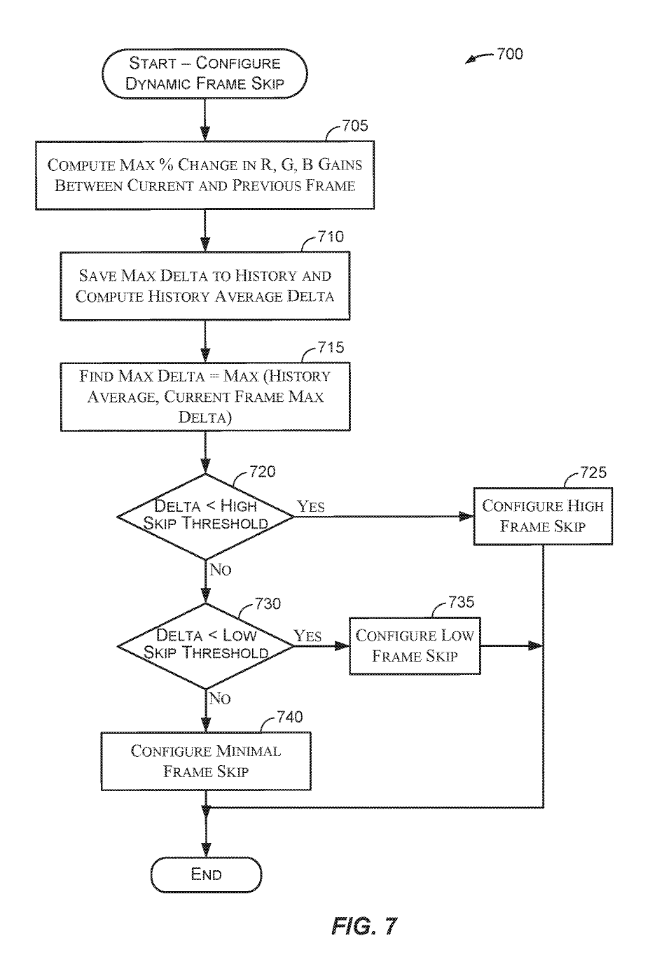

To begin, AWB is initialized. At block 505, the AWB module 140 may check the value of the frame skip count. The value of the frame skip count may be initially set by the block 513 (correlation based frame skip) or block 520 (dynamic frame skipping). In a stable scene or stable lighting environment it is desirable to skip as many frames as possible without degrading the performance of the algorithms (AWB, AEC, etc.). Referring back to block 505, the AWB module may determine if blocks 513, 510 and 520 should be skipped by determining whether the frame skip count is zero or a minimal frame skip value. If the frame skip count is not zero, at block 515 the AWB module 140 decreases the frame skip count, for example, to the minimal frame skip value. The process of setting the frame skip value (as part of the dynamic frame skip) is described in further detail below with reference to block 520 and again with reference to FIG. 7.

At block 505, for non-zero values for the frame skip count, blocks 513 (correlation based frame skipping), 510 (performing of the AWB calculations) and 520 (dynamic frame skipping) are skipped. The value of the frame skip count is decremented at block 515. At block 525, the AWB module 140 applies the decreased frame skip value to subsequently captured image frames to perform AWB calculations and determine AWB gains at the decreased frame skip value. For example, in some instances, the AWB module 140 engages an AWB temporal filter during the frame skips to facilitate smooth convergence of the images during frame skip. At block 530, these AWB gains are used by the ISP 120.

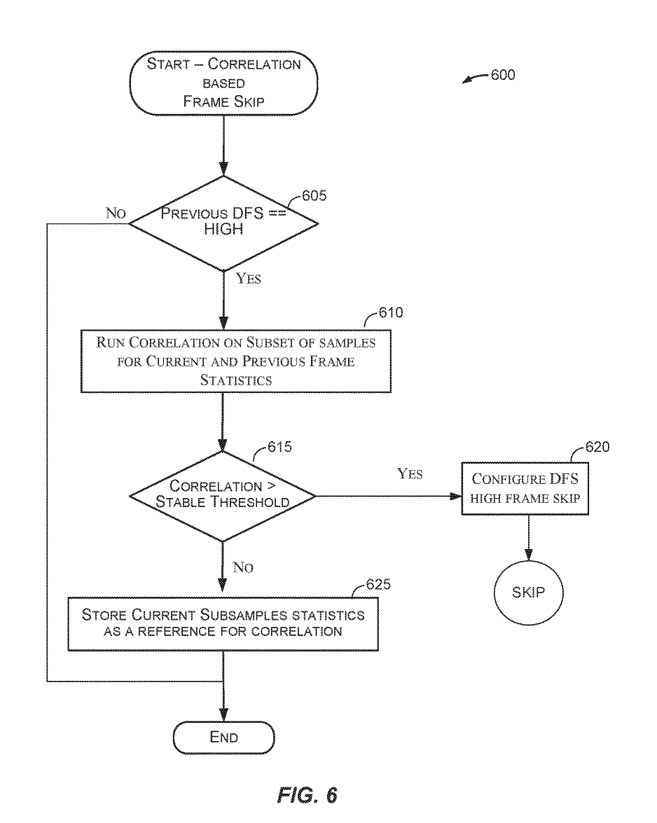

On the other hand, if at block 505, the frame skip count is zero, the AWB module performs a correlation based frame skip determination at block 513 to determine if the AWB processor intensive operations for the current frame statistics can be skipped based on comparing the frame statistics of the current frame to frame statistics of prior frames. Based on the correlation, if the AWB module 140 determines that the AWB calculation for the current frame can be skipped (i.e., the scene is stable), then processes associated with block 510 (performing AWB calculations) and block 520 (configuring dynamic frame skip) are skipped. Furthermore, in certain instances, the correlation based skip module 144 may also reset the frame skip value to the previously configured value by the dynamic skip module 142, so that processing of multiple future frames may be skipped. Correlation based frame skipping is described in more detail in FIG. 6.

However, if the frame is not skipped based on the correlations in block 513, at block 510, the AWB module 140 executes the processor intensive tasks of AWB operations to screen the statistics and run heuristics on captured image frames. Although, this disclosure discusses AWB for illustrative purposes, other image processing functions such as automatic exposure correction, etc., may be performed without deviating from the scope of the disclosure.

At block 520, the AWB process 500 configures dynamic frame skip. In certain embodiments, the frame skip value is determined based on RGB gain values generated by the AWB process 500 at block 510. A more detailed example description of the dynamic frame skip in described with reference to FIG. 7.

Again, as previously described, after performing the AWB operations at 510, the AWB module 140, runs the temporal filter and applies gain adjustments (block 525) so that the AWB gains can be used by the ISP 120.

The correlation based skip module 144 at block 513 allows skipping of the AWB processing of the statistics for the current frame based on the correlation between the current and prior frame statistics. Therefore, block 513 can operate directly on the frame statistics and may not need AWB processing at block 520 for providing its results. High correlation between successive or subsequent frames from a succession of frames may indicate a stable frame with little or no change in the scene in the field of view of the camera. In such instances, AWB processing and other image processing, such as automatic exposure correction, may not be needed. As previously discussed, with reference to FIG. 5, this may allow skipping of the AWB processing (block 510) and configuring of dynamic frame skip (block 520) all together for the current frame and save processing time and energy.

Furthermore, as described in more detail with reference to FIG. 6, for a stable scene detected via high correlations in successive scenes, it may be appropriate to reset the frame skip value to the pre-determined value set by the dynamic skip module 142 previously, thus completely skipping the AWB processing (block 510), dynamic frame skipping computations (block 520) and also correlation based operations (block 513) for one or more forthcoming frames.

In some embodiments, using such a correlation based approach may result in skipping a large number of frames for further processing intensive tasks (e.g., AWB processing).

In certain instances, combining the correlation based frame skipping (block 513) with dynamic frame skipping (block 520) may allow further optimization of the process. For example, in instances where there may be low correlation, but the scene may still be stable (e.g., shake of the camera) the dynamic skip module 142 may still determine (at block 520) that the scene is stable based on the information received from the AWB calculations (block 510). In such instances, the dynamic skip module 142 may reset the frame skip value to a high value and continue skipping frames.

Dynamic skip module 142 operates using information generated by the AWB processing (step 510), such as color temperature and/or RGB gains. Therefore the dynamic skip module 142 can only run after the processor intensive AWB operations are performed at step 510. The dynamic skip module 142, however, generates the number of future frames that the AWB module can skip the correlation based frame skip determination (step 513) and AWB processing (step 510) by setting the frame skip count value.

Therefore, although the correlation based skip module 144 and the dynamic skip module 142 can operate as individual techniques to optimize (i.e., reduce) the AWB processing, the two techniques can also complement each other, as described in FIG. 5 above.

FIG. 6 illustrates a flowchart of an example embodiment of a correlation based frame skipping process 600 running with dynamic frame skipping. For instance, correlation based frame skipping described in FIG. 6 may be used in some implementations as block 513 of the AWB process 500 of FIG. 5. Process 600 can be carried out by correlation based skip module 144 in some examples.

To begin, correlation based frame skip determination is initialized. At block 605, an initial determination may be made if the current frame is a frame from a continuing sequence of subsequent frames from a stable scene based on the configured dynamic frame skip value set. For example, if the dynamic skip module 142 previously determined that the current sequence of frames are part of a stable scene and assigned a high dynamic frame skip value (DFS) then the correlation algorithm may continue to block 610 for determining if a frame skip for the current frame statistics using correlation may be warranted. However, if the DFS value is low, indicating that the current statistics frame may be part of a sequence of a changing scenes (i.e., unstable scene), the process 600 may entirely skip the correlation based skipping of frames and end the process. This is another example, where the dynamic frame skipping and correlation based frame skipping can complement each other in optimizing the use of the processing resources by appropriately determining each other's engagement in the AWB operations.

At block 605, if the DFS value is determined to be high, then the correlation based skip module 144 may execute the correlation algorithm on subsamples for current and previous frame statistics. In certain embodiments, a subset of samples from the frame statistics may be used in determining the correlation. Examples of a correlation of algorithms and techniques used have been previously described with reference to FIG. 3, FIG. 4A and FIG. 4B. Although, any correlation algorithm may be used without deviating from the scope of the disclosure.

At block 615, the correlation based skip module 144 determines if the correlation is high between the previous and the current frames by analyzing the statistics. If the correlation is high, the correlation based skip module 144 may reconfigure the DFS value to the high frame skip value previously set by the dynamic frame skipping module 142 (block 620) and skip the AWB processing (510) and dynamic frame skip configuration (520) in FIG. 5 and save processing resources and power.

However, on the other hand, if the correlation based skip module 144 determines low correlation between the current and prior frames based on analyzing the statistics for each frame, potentially indicating that the current statistics frame may be part of a sequence of a changing scenes (i.e., unstable scene), the process 600 may save the current subsample statistics (e.g., for 256 subset of samples) as a reference for correlation calculations for future frames (block 625) and end the process and continue with AWB processing at step 510 of FIG. 5.

FIG. 7 illustrates a flowchart of an example embodiment of a dynamic frame skipping process 700 that can be used in some implementations as block 520 of the AWB process 500 of FIG. 5. Process 700 can be carried out by dynamic skip module 142 in some examples.

To begin, dynamic frame skip configuration is initialized. At block 705, dynamic frame skip module 142 computes the maximum change of R, G, B gains (“max delta”) between a current frame and a previous frame. This can be computed, in one example, as a maximum percentage change by calculating percentage changes between R, G, and B values of pixels from first and second image frames at corresponding pixel locations and by comparing the percentage changes from each pixel location to identify a largest percentage change. In another example, the maximum change can be computed as a maximum difference value by subtracting R, G, and B values of each pixel from the R, G, and B values of a corresponding pixel location in a different image frame, comparing the difference values, and identifying a largest difference value. Some embodiments may separately compare data from the R, G, and B channels to identify a largest gain of all channels. This largest gain is referred to herein as the “maximum delta.” Some embodiments may consider R, G, and B gains together, for example, by summing or averaging the R, G, and B values at a pixel location. Some embodiments may use only one or two channels of R, G, and B values for calculating the RGB gains. It will be understood that the process 700 can be adapted to operate using channel gains in images in other color spaces, including the RGBN, YCbCr, YUV, and YIQ color spaces, to name a few examples.

At block 710 dynamic frame skip module 142 can save the maximum delta to a history and calculate a history average delta. At block 715, dynamic frame skip module 142 can find the max delta in the history, for example, by max delta=max (history average, current frame max delta).

Dynamic frame skip module 142 can compare the max delta in the history to one or more thresholds. For example, in the illustrated embodiment, at block 720, dynamic frame skip module 142 can compare the max delta to a high skip threshold. If the max delta is less than the high skip threshold, then the process 700 transitions to block 725 and the dynamic frame skip module 142 can output data indicating that AWB calculations are to be performed at a high frame skip. If the max delta is greater than the high skip threshold, then the process 700 transitions to block 730 and the dynamic frame skip module 142 can compare the max delta to a low skip threshold. If the max delta is less than the low skip threshold, then the process 700 transitions to block 735 and the dynamic frame skip module 142 can output data indicating that AWB calculations are to be performed at a low frame skip. If the max delta is greater than the low skip threshold, then the process 700 transitions to block 740 and the dynamic frame skip module 142 can output data indicating that AWB calculations are to be performed with no frame skipping. Accordingly, color channel gains can be used to dynamically vary the rate of performing AWB calculations, conserving computing resources with minimal or no sacrifices for image quality.

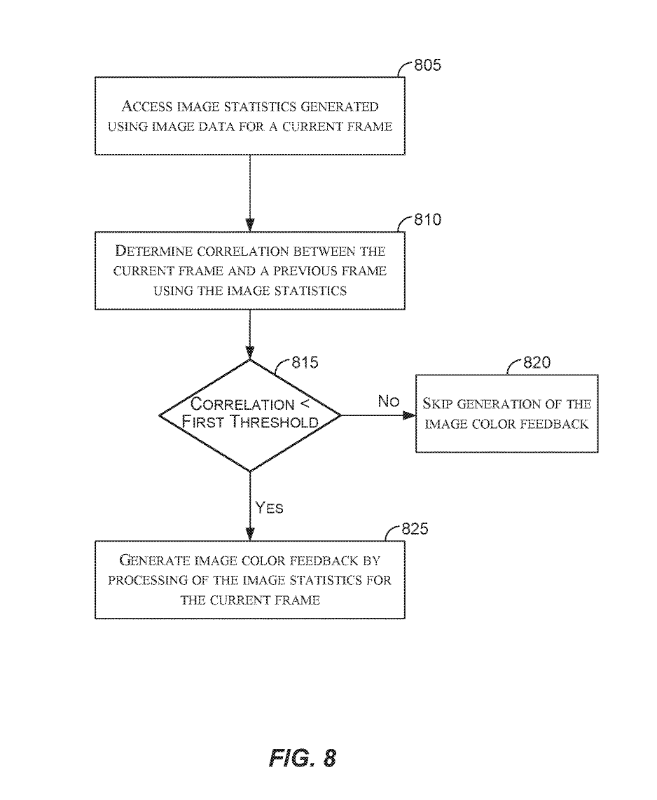

FIG. 8 illustrates another flowchart of an example embodiment of an AWB process 800 implementing correlation based frame skipping techniques described herein.

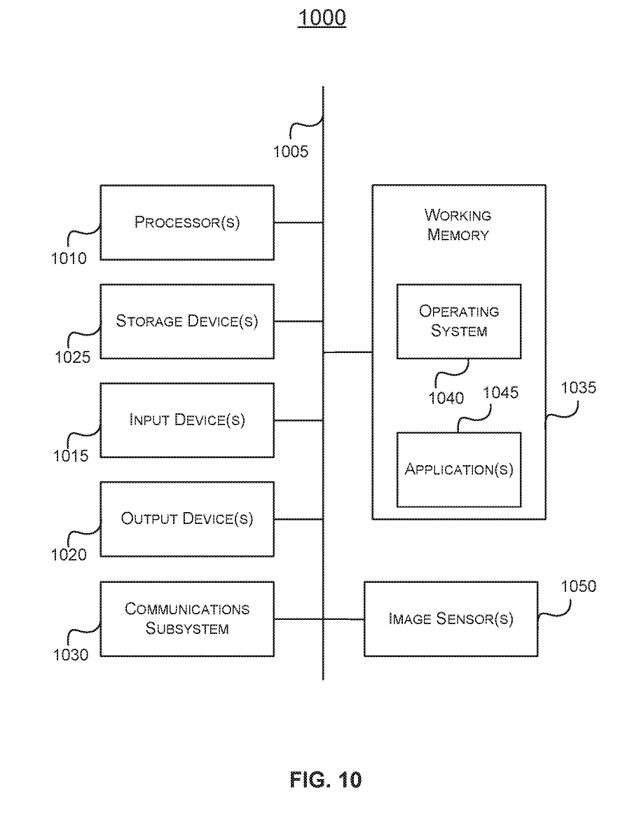

According to one or more aspects, any and/or all of the methods and/or method blocks described herein may be implemented by and/or in a mobile device and/or the device described in greater detail in FIG. 1A, 1B and/or FIG. 10, for instance. In one embodiment, one or more of the method blocks described below with respect to FIG. 8 are implemented by the (analog and/or digital) AWB Module of FIG. 1A and/or one or more processors 160 (e.g., image signal processor 120 and device processor 150) of device 100 or processors 1010 of the computing device 1000, or another processor. Additionally, or alternatively, any and/or all of the methods and/or method blocks described herein may be implemented using one or more components disclosed in FIG. 1A, FIG. 1B and/or FIG. 10. Furthermore, any and/or all of the methods and/or method blocks described herein may be implemented in computer-readable instructions, such as computer-readable instructions stored on a computer-readable medium such as the memory 1035, storage device(s) 1025 or another computer-readable medium.

At block 805, the AWB module 140 may access image statistics generated using image data for a current frame. In certain embodiments, image statistics may be generated using Bayer Grids (illustrated in FIG. 4A). For instance, the image statistics may include red, green and blue information from the image data for each of a plurality of sub-regions of the current frame.

At block 810, the AWB module 140, using the correlation based skip module 144, may determine correlation between the current frame and a previous frame using the image statistics for the current frame and image statistics for the previous frame, wherein the previous frame is a frame prior to the current frame in a sequence of frames. In certain embodiments determining correlation may include generating the correlation using image statistics for a subset of a plurality of sub-regions for the current frame and the previous frames. For example, referring back to FIG. 4B, a few sub-regions from the plurality of sub-regions for a frame may be used in determining the correlation between two frames. In certain embodiments, the statistics for the same sub-regions between two frames are used in deriving the correlation. In certain embodiments, determining correlation may include generating the correlation using image statistics comprising green information for each of a plurality of sub-regions between the current frame and the previous frame.

At block 815, the AWB module 140 may determine if the correlation is below or above a first threshold. In some instances, the first threshold may be automatically determined or pre-configured. For example, in some instances, the first threshold maybe derived using heuristically information.

If the correlation between the statistics for the current frame and the previous frame are below the first threshold, at block 825, the AWB module 140 may generate image color feedback by processing the image statistics for the current frame. In certain embodiments, processing of the image statistics may refer to performing AWB algorithms, AEC algorithms or other image correction algorithms. Furthermore, in certain embodiments, generating image color feedback may refer to generating one or more of color temperature or RGB gains.

If the correlation between the statistics for the current frame and the previous frame are equal to or above the first threshold (i.e., high correlation), at block 820, the AWB module 140 may skip generation of the image color feedback for the frame and move on to the next frame.

In certain embodiments, the AWB module 140 may further perform dynamic frame skipping after generating the image color feedback by processing of the image statistics from the current frame, as described in more detail in FIG. 7. For example, the dynamic skip module 142 of the AWB module 140 may compare the image color feedback for the current frame and an image color feedback for a different previous frame, determine a change between the image color feedback for the current frame and the image color feedback for the different previous frame, based on the comparison, and determine to skip a first number of frames for performing correlation determination and image color feedback generation for future frames, based on determining that the change is below a second threshold (i.e., indicating stable scene). In certain embodiments, after skipping the correlation determination and the image color feedback generation for the first number of frames, the AWB module 140 may receive image statistics for a new frame, determine correlation between the new frame and a previous frame to the new frame using the image statistics for the new frame and image statistics for the previous frame to the new frame, and based on the determination that the correlation is equal to or above the first threshold, skip correlation determination and image color feedback generation for an additional first number of frames. In certain embodiments, the AWB 140 module may also determine correlation and skip frames for future frames based on the determined correlation, if the change is below the second threshold.

It should be appreciated that the specific blocks illustrated in FIG. 8 provide a particular method of switching between modes of operation, according to an embodiment of the present invention. Other sequences of blocks may also be performed accordingly in alternative embodiments. For example, alternative embodiments of the present invention may perform the blocks outlined above in a different order. Furthermore, additional blocks or variations to the blocks may be added or removed depending on the particular applications. One of ordinary skill in the art would recognize and appreciate many variations, modifications, and alternatives of the process.

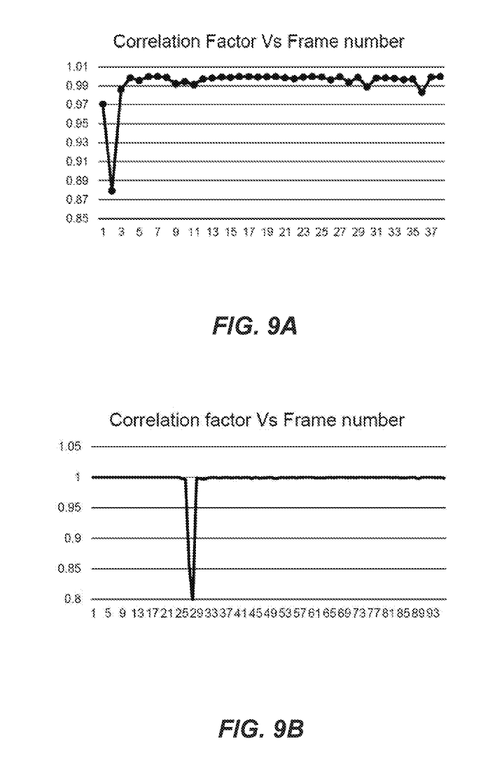

FIG. 9A illustrates example observations of correlation factor vs. frame number for a stable scene, according to practice of certain embodiments disclosed herein. For a stable scene, the correlation factor may be close to 1.0. FIG. 9A illustrates initialization of the device and the stabilization of the correlation factor close to 1 in the third/forth frame after initialization of the device. Certain experimentations indicate that a correlation factor stable threshold of 0.95 works well in detecting scene changes.

FIG. 9B illustrates example observations of correlation factor vs. frame number for an instability in the scene, according to practice of certain embodiments disclosed herein. Scene changes may result in a significant change in the correlation factor. Here, the graph indicates a sudden change in the correlation of the statistics of the current scene with respect to a previous scene around the 28^{th} frame. Such a change in the graph is indicative of a change in the scene. In certain instances, such a change in the scene may result in the AWB processing, according to embodiments disclosed herein.

FIG. 10 illustrates an example computing device 1000 incorporating at least parts of the device or system employed in practicing embodiments of the disclosure. For example, computing device 1000 may represent some of the components of a mobile device or any other computing device disclosed in FIGS. 1A and 1B. Examples of computing device 1000 include, but are not limited to, desktops, workstations, personal computers, supercomputers, video game consoles, tablets, smart phones, laptops, netbooks, or other portable devices. FIG. 10 provides a schematic illustration of one embodiment of computing device 1000 that may perform the methods provided by various other embodiments, as described herein, and/or may function as the host computing device, a remote kiosk/terminal, a point-of-sale device, a mobile multifunction device, a set-top box and/or a computing device. FIG. 10 is meant only to provide a generalized illustration of various components, any or all of which may be utilized as appropriate. FIG. 10, therefore, broadly illustrates how individual system elements may be implemented in a relatively separated or relatively more integrated manner.

Computing device 1000 is shown comprising hardware elements that may be electrically coupled via a bus 1005 (or may otherwise be in communication, as appropriate). The hardware elements may include one or more processors 1010, including, without limitation, one or more general-purpose processors and/or one or more special-purpose processors (such as digital signal processing chips, graphics acceleration processors, and/or the like); one or more input devices 1015, which may include, without limitation, one or more camera sensors 1050, a touch screen, a mouse, a keyboard and/or the like; and one or more output devices 1020, which may include, without limitation, a display unit, a printer and/or the like. Sensors 1050 may include vision sensors, olfactory sensors and/or chemical sensors.

Computing device 1000 may further include (and/or be in communication with) one or more non-transitory storage devices 1025, which may comprise, without limitation, local and/or network accessible storage, and/or may include, without limitation, a disk drive, a drive array, an optical storage device, a solid-form storage device such as a random access memory (“RAM”) and/or a read-only memory (“ROM”), which may be programmable, flash-updateable and/or the like. Such storage devices may be configured to implement any appropriate data storage, including, without limitation, various file systems, database structures, and/or the like.

Computing device 1000 may also include a communications subsystem 1030. Communications subsystem 1030 may include a transceiver for receiving and transmitting data or a wired and/or wireless medium. Communications subsystem 1030 may also include, without limitation, a modem, a network card (wireless or wired), an infrared communication device, a wireless communication device and/or chipset (such as a Bluetooth™ device, an 802.11 device, a WiFi device, a WiMax device, cellular communication facilities, etc.), and/or the like. Communications subsystem 1030 may permit data to be exchanged with a network, other computing devices, and/or any other devices described herein. In many embodiments, computing device 1000 may further comprise a non-transitory working memory 1035, which may include a RAM or ROM device, as described above.

Computing device 1000 may comprise software elements, shown as being currently located within the working memory 1035, including an operating system 1040, device drivers, executable libraries, and/or other code, such as one or more application programs 1045, which may comprise computer programs provided by various embodiments, and/or may be designed to implement methods, and/or configure systems, provided by other embodiments, as described herein. Merely by way of example, one or more procedures described with respect to the method(s) discussed above might be implemented as code and/or instructions executable by a computer (and/or a processor within a computer); in an aspect, then, such code and/or instructions may be used to configure and/or adapt a general purpose computer (or other device) to perform one or more operations in accordance with the described methods.

A set of these instructions and/or code might be stored on a computer-readable storage medium, such as storage device(s) 1025 described above. In some cases, the storage medium might be incorporated within a computing device, such as computing device 1000. In other embodiments, the storage medium might be separate from a computing device (e.g., a removable medium, such as a compact disc), and/or provided in an installation package, such that the storage medium may be used to program, configure and/or adapt a general purpose computer with the instructions/code stored thereon. These instructions might take the form of executable code, which is executable by computing device 1000 and/or might take the form of source and/or installable code, which, upon compilation and/or installation on computing device 1000 (e.g., using any of a variety of generally available compilers, installation programs, compression/decompression utilities, etc.) then takes the form of executable code.

Substantial variations may be made in accordance with specific requirements. For example, customized hardware might also be used, and/or particular elements might be implemented in hardware, software (including portable software, such as applets, etc.), or both. Further, connection to other computing devices 1000 such as network input/output devices may be employed.

Some embodiments may employ a computing device (such as computing device 1000) to perform methods in accordance with the disclosure. For example, some or all of the procedures of the described methods may be performed by computing device 1000 in response to processor 1010 executing one or more sequences of one or more instructions (which might be incorporated into operating system 1040 and/or other code, such as an application program 1045) contained in working memory 1035. Such instructions may be read into working memory 1035 from another computer-readable medium, such as one or more of storage device(s) 1025. Merely by way of example, execution of the sequences of instructions contained in working memory 1035 might cause processor(s) 1010 to perform one or more procedures of the methods described herein.

The terms “machine-readable medium” and “computer-readable medium,” as used herein, refer to any medium that participates in providing data that causes a machine to operate in a specific fashion. In an embodiment implemented using computing device 1000, various computer-readable media might be involved in providing instructions/code to processor(s) 1010 for execution and/or might be used to store and/or carry such instructions/code (e.g., as signals). In many implementations, a computer-readable medium is a physical and/or tangible storage medium. Such a medium may take many forms, including, but not limited to, non-volatile media, volatile media, and transmission media. Non-volatile media include, for example, optical and/or magnetic disks, such as storage device(s) 1025. Volatile media include, without limitation, dynamic memory, such as working memory 1035. Transmission media include, without limitation, coaxial cables, copper wire and fiber optics, including the wires comprising the bus 1005, as well as the various components of communications subsystem 1030 (and/or the media by which communications subsystem 1030 provides communication with other devices). Hence, transmission media may also take the form of waves (including, without limitation, radio, acoustic and/or light waves, such as those generated during radio-wave and infrared data communications). In an alternate embodiment, event-driven components and devices, such as cameras, may be used, where some of the processing may be performed in analog domain.

Common forms of physical and/or tangible computer-readable media include, for example, a floppy disk, a flexible disk, hard disk, magnetic tape, or any other magnetic medium, a CD-ROM, any other optical medium, punch cards, paper tape, any other physical medium with patterns of holes, a RAM, a PROM, EPROM, a FLASH-EPROM, any other memory chip or cartridge, a carrier wave as described hereinafter, or any other medium from which a computer may read instructions and/or code.

Various forms of computer-readable media may be involved in carrying one or more sequences of one or more instructions to processor(s) 1010 for execution. Merely by way of example, the instructions may initially be carried on a magnetic disk and/or optical disc of a remote computer. A remote computer might load the instructions into its dynamic memory and send the instructions as signals over a transmission medium to be received and/or executed by the computing device 1000. These signals, which might be in the form of electromagnetic signals, acoustic signals, optical signals and/or the like, are all examples of carrier waves on which instructions may be encoded, in accordance with various embodiments of the invention.

Communications subsystem 1030 (and/or components thereof) generally will receive the signals, and bus 1005 then might carry the signals (and/or the data, instructions, etc., carried by the signals) to working memory 1035, from which processor(s) 1010 retrieves and executes the instructions. The instructions received by working memory 1035 may optionally be stored on a non-transitory storage device 1025 either before or after execution by processor(s) 1010.

The methods, systems, and devices discussed above are examples. Various embodiments may omit, substitute, or add various procedures or components as appropriate. For instance, in alternative configurations, the methods described may be performed in an order different from that described, and/or various stages may be added, omitted, and/or combined. Also, features described with respect to certain embodiments may be combined in various other embodiments. Different aspects and elements of the embodiments may be combined in a similar manner. Also, technology evolves and, thus, many of the elements are examples that do not limit the scope of the disclosure to those specific examples.

Specific details are given in the description to provide a thorough understanding of the embodiments. However, embodiments may be practiced without these specific details. For example, well-known circuits, processes, algorithms, structures, and techniques have been shown without unnecessary detail in order to avoid obscuring the embodiments. This description provides example embodiments only, and is not intended to limit the scope, applicability, or configuration of the invention. Rather, the preceding description of the embodiments will provide those skilled in the art with an enabling description for implementing embodiments of the invention. Various changes may be made in the function and arrangement of elements without departing from the spirit and scope of the invention.

Also, some embodiments were described as processes depicted as flow diagrams or block diagrams. Although each may describe the operations as a sequential process, many of the operations may be performed in parallel or concurrently. In addition, the order of the operations may be rearranged. A process may have additional steps not included in the figure. Furthermore, embodiments of the methods may be implemented by hardware, software, firmware, middleware, microcode, hardware description languages, or any combination thereof. When implemented in software, firmware, middleware, or microcode, the program code or code segments to perform the associated tasks may be stored in a computer-readable medium such as a storage medium. Processors may perform the associated tasks.

It will be apparent to those skilled in the art that substantial variations may be made in accordance with specific requirements. For example, customized hardware might also be used, and/or particular elements might be implemented in hardware, software (including portable software, such as applets, etc.), or both. Further, connection to other computing devices such as network input/output devices may be employed.

With reference to the appended figures, components that can include memory can include non-transitory machine-readable media. The term “machine-readable medium” and “computer-readable medium” as used herein, refer to any storage medium that participates in providing data that causes a machine to operate in a specific fashion. In embodiments provided hereinabove, various machine-readable media might be involved in providing instructions/code to processing units and/or other device(s) for execution. Additionally, or alternatively, the machine-readable media might be used to store and/or carry such instructions/code. In many implementations, a computer-readable medium is a physical and/or tangible storage medium. Such a medium may take many forms, including, but not limited to, non-volatile media, volatile media, and transmission media. Common forms of computer-readable media include, for example, magnetic and/or optical media, punch cards, paper tape, any other physical medium with patterns of holes, a RAM, a PROM, EPROM, a FLASH-EPROM, any other memory chip or cartridge, a carrier wave as described hereinafter, or any other medium from which a computer can read instructions and/or code.

Those of skill in the art will appreciate that information and signals used to communicate the messages described herein may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Terms, “and” and “or” as used herein, may include a variety of meanings that also is expected to depend at least in part upon the context in which such terms are used. Typically, “or” if used to associate a list, such as A, B, or C, is intended to mean A, B, and C, here used in the inclusive sense, as well as A, B, or C, here used in the exclusive sense. In addition, the term “one or more” as used herein may be used to describe any feature, structure, or characteristic in the singular or may be used to describe some combination of features, structures, or characteristics. However, it should be noted that this is merely an illustrative example and claimed subject matter is not limited to this example. Furthermore, the term “at least one of” if used to associate a list, such as A, B, or C, can be interpreted to mean any combination of A, B, and/or C, such as A, AB, AA, AAB, AABBCCC, etc.

Having described several embodiments, various modifications, alternative constructions, and equivalents may be used without departing from the spirit of the disclosure. For example, the above elements may merely be a component of a larger system, wherein other rules may take precedence over or otherwise modify the application of the embodiments described herein. Also, a number of steps may be undertaken before, during, or after the above elements are considered. Accordingly, the above description does not limit the scope of the disclosure.

What is claimed is:

1. A device for capturing images, comprising:
a sensor configured to sense image data for a current frame;
a processor configured to:
receive image statistics generated using the image data for the current frame;
determine correlation between the current frame and a previous frame using the image statistics for the current frame and image statistics for the previous frame, wherein the previous frame is a frame prior to the current frame in a sequence of frames;
determine whether the correlation is below a first threshold; and
based on the determination that the correlation is below the first threshold, generate image color feedback by processing of the image statistics for the frame.

2. The device of claim 1, wherein based on the determination that the correlation is equal to or above the first threshold, the processor is configured to skip generating the image color feedback by skipping processing of the image statistics for the current frame.

3. The device of claim 1, wherein the image statistics for the current frame comprises deriving red, green and blue information from the image data for each of a plurality of sub-regions of the current frame.

4. The device of claim 1, wherein determining correlation comprises generating the correlation by the processor using green information from the image statistics for each of a plurality of sub-regions between the current frame and the previous frame.

5. The device of claim 1, wherein determining correlation comprises generating the correlation by the processor using a subset of the image statistics associated with a subset of a plurality of sub-regions for the current frame and the previous frames.

6. The device of claim 1, wherein processing of the image statistics comprises performing, by the processor, automatic white balancing operations.

7. The device of claim 1, wherein processing of the image statistics comprises performing, by the processor, automatic exposure correction operations.

8. The device of claim 1, wherein the image color feedback is one or more of color temperature or red, blue, green (RGB) gains.

9. The device of claim 1, further comprising performing dynamic frame skipping after generating the image color feedback by processing of the image statistics from the current frame.

10. The device of claim 1, wherein the processor is configured to determine correlation for future frames for skipping the future frames if the current frame is determined to be a frame from a stable scene using dynamic frame skipping.

11. The device of claim 1, wherein the processor is further configured to:
compare, after generating the image color feedback for the current frame, the image color feedback for the current frame and an image color feedback for a different previous frame;
determine a change between the image color feedback for the current frame and the image color feedback for the different previous frame, based on the comparison; and
determine to skip a first number of frames for performing correlation determination and image color feedback generation for future frames, based on determining that the change is below a second threshold.

12. The device of claim 11, wherein, upon skipping the correlation determination and the image color feedback generation for the first number of frames, the processor is further configured to:
receive image statistics for a new frame;
determine correlation between the new frame and a previous frame to the new frame using the image statistics for the new frame and image statistics for the previous frame to the new frame; and
based on the determination that the correlation is equal to or above the first threshold, skip correlation determination and image color feedback generation for an additional first number of frames.

13. The device of claim 1, wherein the processor is an image signal processor.

14. The device of claim 1, wherein the processor is a general purpose processor.

15. The device of claim 1, wherein the device is a mobile device.

16. A method for capturing images, comprising:
accessing image statistics generated using image data for a current frame, wherein image statistics comprises red, green and blue information from the image data for each of a plurality of sub-regions of the current frame;
determining correlation between the current frame and a previous frame using the image statistics for the current frame and image statistics for the previous frame, wherein the previous frame is a frame prior to the current frame in a sequence of frames;
determining whether the correlation is below a first threshold; and
based on the determination that the correlation is below the first threshold, generating image color feedback by processing of the image statistics for the current frame.

17. The method of claim 16, further comprising based on the determining that the correlation is equal to or above the first threshold, skipping generation of the image color feedback by skipping processing of the image statistics for the current frame.

18. The method of claim 16, wherein processing of the image statistics comprises performing automatic white balancing operations.

19. The method of claim 16, wherein determining correlation comprises generating the correlation using green information from the image statistics for each of the plurality of sub-regions between the current frame and the previous frame.

20. The method of claim 16, wherein the image color feedback is one or more of color temperature or red, blue, green (RGB) gains.

21. The method of claim 16, further comprising
comparing, after generating the image color feedback for the current frame, the image color feedback for the current frame and an image color feedback for a different previous frame;
determining a change between the image color feedback for the current frame and the image color feedback for the different previous frame, based on the comparison; and
determining to skip a first number of frames for performing correlation determination and image color feedback generation for future frames, based on determining that the change is below a second threshold.

22. The method of claim 21, wherein, upon skipping the correlation determination and the image color feedback generation for the first number of frames, the method further comprises:
receiving image statistics for a new frame;
determining correlation between the new frame and a previous frame to the new frame using the image statistics for the new frame and image statistics for the previous frame to the new frame; and
based on the determination that the correlation is equal to or above the first threshold, skip correlation determination and image color feedback generation for an additional first number of frames.

23. The method of claim 16, further comprising determining correlation for future frames for skipping the future frames if the current frame is determined to be a frame from a stable scene using dynamic frame skipping.

24. An apparatus for capturing images, comprising:
means for accessing image statistics generated using image data for a current frame, wherein image statistics comprises red, green and blue information from the image data for each of a plurality of sub-regions of the current frame;
means for determining correlation between the current frame and a previous frame using the image statistics for the current frame and image statistics for the previous frame, wherein the previous frame is a frame prior to the current frame in a sequence of frames;
means for determining whether the correlation is below a first threshold; and
based on the determination that the correlation is below the first threshold, means for generating image color feedback by processing of the image statistics for the current frame.

25. The apparatus of claim 24, further comprising based on the determining that the correlation is equal to or above the first threshold, means for skipping generation of the image color feedback by skipping processing of the image statistics for the current frame.

26. The apparatus of claim 24, wherein processing of the image statistics comprises performing automatic white balancing operations.

27. The apparatus of claim 24, wherein the image color feedback is one or more of color temperature or red, blue, green (RGB) gains.

28. A non-transitory computer-readable storage medium including machine-readable instructions stored thereon for:
accessing image statistics generated using image data for a current frame, wherein image statistics comprises red, green and blue information from the image data for each of a plurality of sub-regions of the current frame;
determining correlation between the current frame and a previous frame using the image statistics for the current frame and image statistics for the previous frame, wherein the previous frame is a frame prior to the current frame in a sequence of frames;
determining whether the correlation is below a stable threshold; and
based on the determination that the correlation is below the stable threshold, means for generating image color feedback by processing of the image statistics for the current frame.

29. The non-transitory computer-readable storage medium of claim 28, further comprising, based on the determining that the correlation is equal to or above the stable threshold, means for skipping generation of the image color feedback by skipping processing of the image statistics for the current frame.

30. The non-transitory computer-readable storage medium of claim 28, wherein processing of the image statistics comprises performing automatic white balancing operations.
